(19) United States
(12) Patent Application Publication
(10) Pub. No.: US 2003/0085214 A1
(43) Pub. Date: May 8, 2003

(54) Micro-glow plug and method of making same field of the invention

(75) Inventors: Li-Anne Liew, Lakewood, CO (US); Rishi Raj, Boulder, CO (US)

Correspondence Address: PATTON BOGGS, PO BOX 270930, LOUISVILLE, CO, 80027, US

(73) Assignee: University of Colorado At Boulder

(21) Appl. No.: 10/010,633

(22) Filed: Nov. 7, 2001

(51) Int. Cl. F23Q 7/00; F23Q 7/22; H05B 3/00

(52) U.S. Cl. 219/270; 123/145 A; 29/611

(57) ABSTRACT

A ceramic micro-glow plug made from three primary constituents, silicon, carbon and nitrogen by forming a precursor liquid polymer in a mold or by photolithograpy, drying, pyrolizing and annealing. A U-shaped design with two arms joined at thin tip, and the composition of the silicon carbon-nitride ceramic allow the tip to reach a high operating temperature with a minimum power applied across the electrical contacts. When the tip is at the highest operating temperature, the remainder of the structure remains relatively cool. In an embodiment, an additional component such as boron is added to the silicon carbon-nitride to increase the electrical conductivity of the micro-glow plug. In another embodiment, a plurality of micro-glow plugs are attached to a body wherein when the operational micro-glow plug fails, the next successive micro-glow plug receives power across its electrical contacts.

### FIELD OF THE INVENTION

The invention relates to temperature ignition devices, and in particular, to a high temperature glow plug for diesel and other engines.

### Problem

Glow plugs are commonly used in diesel engines, natural gas engines, engines that burn pulverized coal, as well as other specialized engines and applications. It is a problem in the field of glow plugs to provide a glow plug that requires less power to reach and maintain an operating temperature while also providing a glow plug that quickly reaches a higher operating temperature from a cold start. Two types of glow plugs are commonly known. The first has a metal heating element encased in a ceramic insulating body and the second has a ceramic heating element disposed in a metal body. The ceramic elements are typically constructed from composites of polycrystalline silicon nitride, silicon carbide and molybdenum disilicide.

Metal Heating Element

The ceramic glow plug heater disclosed in U.S. Pat. No. 6,018,142 issued Jan. 25, 2000 to Lee et al. includes a metal heating element, preferably a wire, with a coating on the wire to act as a barrier to the diffusion of silicon. The coated wire is embedded in a powder comprising silicon nitrate, silicon carbide, or a mixture of the two which is heated under pressure to form a sintered ceramic body around the coated wire. The process of fabricating the ceramic glow plug in Lee et al. requires first coating a wire heating element, then embedding the coated wire in a powder that is heated to form a sintered ceramic body; this involves three separate elements in three processes to fabricate a single ceramic glow plug heater.

Another glow plug with a metal heating element is disclosed in U.S. Pat. No. 6,037,568 issued Mar. 14, 2000 to Hatanaka et al. In Hatanaka et al., the heat-generating coil is a helical resistor made of a conductive metal material. To control heating, a second helical resistor operates as a control coil. Unlike the previously described heating element, the heat generating and control coils are embedded in a heat-resistant insulating powder within a heat resistant metal sheath. Again, three separate elements are necessary to fabricate a single glow plug heater.

The glow plugs with metal heating elements just described are complex, requiring at a minimum a metal heater, a sheath surrounding the metal heater and usually a body, or housing. Increasing the complexity of the glow plug results in increased cost to produce each glow plug which in turn affects the cost of the glow plug to the consumer. Increasing the number of components required also results in a large glow plug that requires excessive power to reach and maintain a high operating temperature.

Ceramic Heating Element with Metal Housing

The glow plug disclosed in U.S. Pat. No. 6,054,680 issued Apr. 25, 2000 to Locher et al. comprises a ceramic heating apparatus and a cylindrical metal tube holding the ceramic heating apparatus. The ceramic heating apparatus is electrically conductive and has a sleeve integral to one end of the apparatus for interconnecting the ceramic heating apparatus to the metal tube. Since the ceramic is electrically conductive, the cylindrical metal tube is electrically insulated. The ceramic heating apparatus disclosed in Locher et al. is a U-shaped apparatus having a smaller cross-sectional dimension at the tip of the U-shaped apparatus such that the resistance at the tip is increased so that the ceramic heating apparatus glows first at this point.

The ceramic heating element sidewalls have been reduced in area to decrease their electrical resistance while the thickness at the tip of the ceramic heating element is not decreased. Thus, the sidewalls allow a greater current to the tip where the increase in resistance results in faster attainment of the required operating temperature.

However, Locher et al. fails to provide an apparatus wherein the sides of the U-shaped ceramic heating apparatus remain relatively cold while the tip reaches and maintains a high operating temperature. Instead, the ceramic glow plug in Locher et al. modifies the structure of the ceramic heating element for a faster attainment of operating temperature at the point where the cross-section is decreased with no change in the nature of the material from which the ceramic heating element is fabricated.

The glow plugs just described, whether having metal or ceramic heating elements, are large, typically have a length of 30 mm to 50 mm, resulting in a typical power rating of 100 watts. The glow plug temperature at the tip is typically in the area of 1200° C. and has a response time (the time to reach operating temperature from a cold start) that ranges between one second and ten seconds. The response time is proportional to the glow plug size and power applied to the glow plug; i.e., the larger the surface area, the longer the time required to reach operating temperature. The ceramic and metal heating elements reach their highest operating temperature throughout the heating element, not just at the tip, thus requiring additional power to reach and maintain a high operating temperature. Use of glow plugs is often in a vehicle having a battery with limited power available; the longer the glow plug requires to reach and maintain operating temperature, the greater the drain of the limited battery supply.

For these reasons, a need exists for a micro-glow plug that is simple and economical to manufacture and use and exceeds the operating characteristics of conventional glow plugs having metal or ceramic heating elements encased in a metal or ceramic sheath.

### Solution

The present invention overcomes the problems outlined above and advances the art by providing a glow plug that is manufactured from one continuous component, thus reducing the overall size of the glow plug. Preferably, the glow plug comprises an ultrahigh temperature micro-glow plug designed to create a small hot spot at the tip, preferably about one-tenth of a millimeter in size. Preferably, the remainder of the glow plug remains relatively cool even when the tip is at its highest temperature.

The micro-glow plug comprises a singular ceramic structure wherein the electrical contacts, arms, and the tip of the glow plug each carry the same current. Preferably, the glow plug is U-shaped. The cross section of the micro-glow plug is preferably constricted at the tip to increase the electrical resistance, thereby creating a highly localized hot spot in the micro-glow plug. Reducing the area required to reach a high operating temperature reduces the power required for the micro-glow plug to reach and maintain a high operating temperature.

Ceramic Structure

In the preferred embodiment, the micro-glow plug is made from a single polymer-derived ceramic material known as silicon carbon-nitride. This silicon carbon-nitride embodies mechanical and chemical properties that are needed to withstand thermal shock, oxidation and deformation at temperatures of up to 1500° C.

It may also be doped with boron, aluminum or phosphorous to increase its electrical conductivity, which makes it more suitable for the micro-glow plug application. The present ultrahigh temperature micro-glow plug ceramic structure is preferably fabricated from these polymer-derived ceramics by a low cost lithographic process.

Molding the Ceramic Structure

The ceramic material is preferably made from a liquid precursor, preferably comprising a polymer liquid that can be easily shaped into the micro-sized glow plug. Once solid polymer micro-components have been made, preferably by drying the precursor, they are cross-linked and pyrolyzed, preferably in a nitrogen atmosphere. Thermal decomposition of the polymer transforms it into the ceramic, which is preferably SiCN, which is a lustrous-black, amorphous bulk ceramic. By controlling the material processing steps, various properties such as electrical conductivity, oxidation and corrosion resistance, and thermal shock resistance are imparted to the material.

Micro-glow Plug System

In the preferred embodiment, the small scale, the simplicity of the design and manufacturing system, and the extremely low production cost permits the creation of an array of micro-glow plugs that form a system, the Micro-glow Plug System (MPS). The MPS comprises a plurality of micro-glow plugs integrally connected, preferably to a cylindrical body. Preferably, only one micro-glow plug is operational at a time. In the preferred embodiment of the MPS, a current sending device, such as a current meter, monitors the current draw to the operational micro-glow plug system. When the current draw decreases to a predetermined level, a signal is sent to a switching apparatus. Thus, when the first micro-glow plug fails, the switching apparatus switches power to the next successive micro-glow plug. Increasing the number of micro-glow plugs attached to the body can increase the total life of the micro-glow plug system. The design in this embodiment allows great flexibility in optimizing the performance and the cost of the micro-glow plug system.

The invention provides a method of fabricating a ceramic micro-glow plug, the method comprising: providing a liquid precursor including chemical elements suitable for forming the ceramic; forming a solid micro-glow plug utilizing the liquid precursor; and treating the solid micro-glow plug to form an electrically conductive ceramic micro-glow plug. Preferably, forming a solid micro-glow plug comprises: forming a mold for the electrically conductive ceramic micro-glow plug; applying the liquid precursor into the mold; solidifying the liquid precursor in the mold; and removing the micro-glow plug from the mold. Preferably, the solidifying comprises exposing the molded precursor liquid to ultra-violet light. Preferably, the solidifying comprises heating the precursor liquid. Preferably, the forming of a mold comprises forming the mold into a photoresist on a silicon wafer. Preferably, the method further comprises coating the mold with a layer of Teflon™. Preferably, the providing of a precursor liquid includes adding a photo-initiator to make the precursor liquid photosensitive. Preferably, the forming comprises spin-coating. Alternatively, the forming of a solid micro-glow plug comprises a photolithographical patterning process. Preferably, the photolithographical process comprises: transferring a micro-glow plug design onto a glass mask; coating the glass mask with a Teflon™ coating; dispensing the liquid precursor on a substrate; placing the glass mask in contact with the precursor on the substrate spaced at a predetermined height, wherein the predetermined height between the substrate and the glass mask determines the thickness of the solid micro-glow plug; exposing the liquid precursor to ultra-violet light through the mask to solidify the liquid precursor according to the glass mask; removing the remaining liquid precursor from the substrate; and removing the solid micro-glow plug from the wafer. Preferably, treating comprises pyrolysis of the solid micro-glow plug at a temperature from 900° C. to 1100° C. Preferably, the pyrolysis comprises heating at a temperature of 1000° C. Preferably, the treating comprises annealing the solid micro-glow plug at a temperature from 1300° C. to 1500° C. Preferably, the annealing comprises heating at a temperature of 1400° C. Preferably, the chemical elements include silicon, carbon and nitrogen, and the ceramic comprises a silicon carbon-nitride.

In another aspect, the invention provides a micro-glow plug, comprising: a ceramic heating element having a first arm having a first width, a second arm having a second width, and a tip having a third width that is less than the first and second widths, the first arm and second arm connected to the tip; and a first connecting apparatus for electrically connecting a voltage source across the first arm and the second arm so that when current is applied to the connecting apparatus a current flows through the ceramic heating element, wherein the current density at the tip is increased due to the decreased third width of the tip to generate a high operating temperature at the tip, while the first arm and the second arm remain relatively cool. Preferably, the first width and the second width are substantially equal. Preferably, the ceramic heating element comprising a silicon, carbon, and nitrogen composition. Preferably, the ceramic heating element of silicon, carbon, and nitrogen composition further comprises: Siₓ wherein x ranges between 1.0 and 4.0; C_{y} wherein y ranges between 1.1 and 3.0; and N_{z}, wherein z ranges between 0.0 and 4.0. Preferably, the ceramic heating element further comprises a metallic element. Preferably, the atom concentration of the metallic element falls within a range of 0.0 to 2.0 for every silicon atom. Preferably, the metallic element comprises boron. Preferably, the metallic element comprises aluminum. Preferably, the micro-glow plug material further comprises phosphorous, wherein the atom concentration of the phosphorous falls within a range of 0.0 to 2.0 for every silicon atom. Preferably, the micro-glow plug further comprises an oxide coating to protect the ceramic heating element from corrosion. Preferably, the micro-glow plug further comprises: a body having a first end and a second end; and two or more ceramic heating elements integrally connected to the first end of the body, the first arm of the two or more micro-glow plugs interconnected; and wherein the connecting apparatus comprises a switching voltage source and a switch apparatus for electrically connecting the switching voltage source across the interconnected first arm of the two or more ceramic heating elements and each second arm of the two or more ceramic heating elements so that a current flows through a first one of the two or more ceramic heating elements and the switching voltage source switches voltage to the next second arm of the next one of the two or more ceramic heating elements when the first one of the two or more ceramic heating elements fails. Preferably, the body is cylindrical.

In another aspect, the invention provides a micro-glow plug system comprising: a body having two or more micro-glow plugs integrally connected to the body; a switching apparatus for switching power between the two or more micro-glow plugs; a sensor to monitor a current flow to the two or more micro-glow plugs wherein when the current flow falls below a predetermined level the sensor sends a signal to the switching apparatus and the switching apparatus switches the power to a next one of the two or more micro-glow plugs. Preferably, the micro-glow plug system further includes a source of the power, and wherein the sensor is connected in serial between the switching apparatus and the power source. Preferably, the switching apparatus comprises a plurality of controlled switches each having a control terminal and a controller for switching the power to the control terminal of a corresponding one of the plurality of controlled switches.

In another aspect, the invention provides a micro-glow plug made from a single ceramic material in which the largest dimension is 2 (two) millimeters or less, and with a glow tip of a size 0.2 (two tenths) of a millimeter or less. Preferably, the micro-glow plug is made of a material comprising silicon, carbon and nitrogen. Preferably, the micro-glow plug is coated with an oxide coating to protect it from corrosion. Preferably, the material is described by the composition SiₓC_{y}N_{z}, where x, y and z fall in the following ranges: x=1 to 4, y=1.1 to 3.0, and z=0 to 4. Preferably, the material further comprises a metallic element. Preferably, the atom concentration of the metallic element falls within a range of 0.0 to 2.0 for every silicon atom. Preferably, the metallic element comprises boron. Alternatively, the metallic element comprises aluminum. Preferably, the micro-glow plug further comprises phosphorous, wherein the atom concentration of the phosphorous falls within a range of 0.0 to 2.0 for every silicon atom. Preferably, the glow tip reaches a temperature of 1200° C. to 1600° C. for ignition. Preferably, the glow tip is capable of reaching a temperature of 1500° C. Preferably, the micro-glow plug uses 5.0 watts of power or less to reach and maintain its highest operating temperature. Preferably, the micro-glow plug uses 1.0 watt of power or less to reach and maintain its highest operating temperature. Preferably, the micro-glow plug reaches its glow temperature in one-half of a second or less from a cold start.

In a further aspect, the invention provides a micro-glow plug that reaches its glow temperature in one-half of a second or less from a cold start.

In still a further aspect, the invention provides a micro-glow plug having a glow tip, a current carrying section for carrying current to the glow tip, a glow tip, and a plurality of contact pads for connecting to an electrical circuit, the glow tip having an electrical resistance of ten times or more as compared to the current carrying section.

In yet another aspect, the invention provides a system of micro-glow plugs (MPS) comprising an array of micro-glow plugs connected on a single supporting device. Preferably, the total number of micro-glow plugs in the MPS range from two to one thousand. Preferably, the system further includes an electrical circuit that switches the operation of the MPS from one of the micro-glows plug to the next until all of the micro-glow plugs in the MPS are exhausted. Preferably, the system further includes a circuit for producing an electrical signal providing information on the remaining expected life of the MPS.

A first advantage of the present ultrahigh temperature micro-glow plug is to provide a micro-glow plug with a decreased overall size that exceeds the operating characteristics of conventional glow plugs. Fabrication of the present ultrahigh temperature micro-glow plug from a single silicon carbon-nitride structure reduces the manufacturing cost. Integrally connecting a plurality of micro-glow plugs to a single body that switches power from one micro-glow plug to the next successive micro-glow plug increases the life-cycle of the micro-glow plug system, resulting in increased reliability. Numerous other features and advantages of the glow plug and MPS according to the invention will become apparent from the detailed description below when read in conjunction with the following drawings.

### BRIEF DESCRIPTION OF THE DRAWINGS

FIG. 1 illustrates a glow plug of the prior art;

FIG. 2 illustrates a preferred embodiment of a micro-glow plug structure according to the invention;

FIG. 3 illustrates approximate structure dimensions of an embodiment of the present ultrahigh temperature micro-glow plug;

FIG. 4 illustrates a flow diagram of a preferred method of molding the present ultrahigh temperature micro-glow plug structure;

FIG. 5 illustrates a flow diagram of an alternative preferred method of molding the present ultrahigh temperature micro-glow plug structure;

FIG. 6 illustrates a flow diagram of a preferred method of developing the electrical characteristics of the present ultrahigh temperature micro-glow plug structure;

FIG. 7 illustrates a preferred micro-glow plug system embodiment of the present ultrahigh temperature micro-glow plug;

FIG. 8 illustrates an electrical schematic diagram of the micro-glow plug system embodiment utilizing the present ultrahigh temperature micro-glow plug; and

FIG. 9 illustrates an electrical schematic diagram of another micro-glow plug system embodiment utilizing the present ultrahigh temperature micro-glow plug.

### DETAILED DESCRIPTION

The micro-glow plug summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

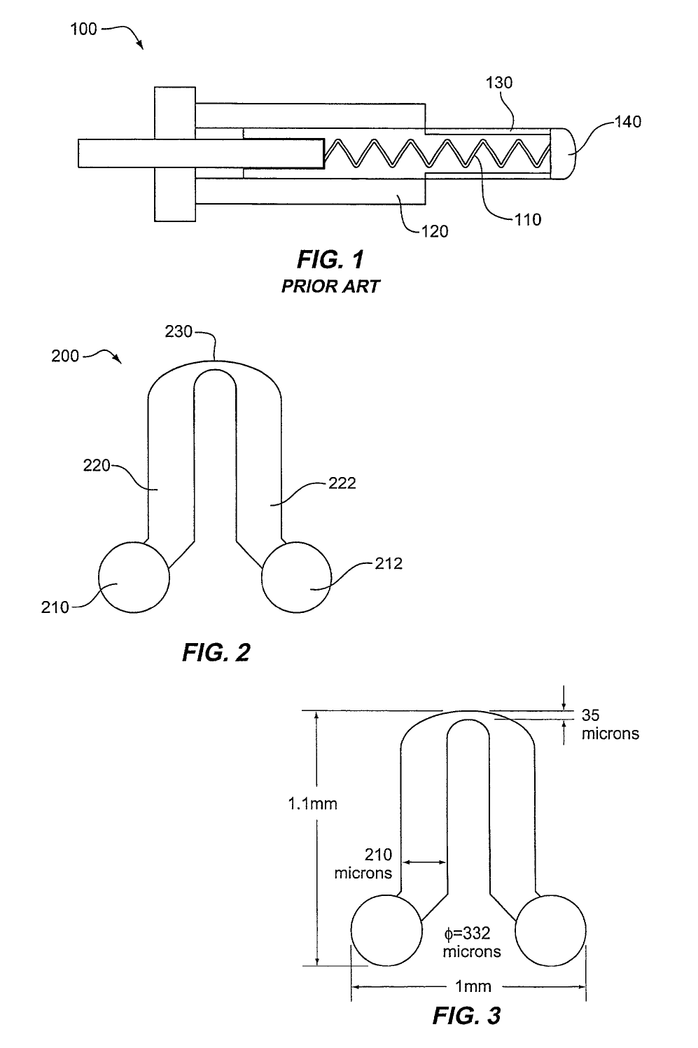

Prior Art—FIG. 1:

Referring to FIG. 1, conventional designs of a glow plug 100 comprise a heating element 110, an encasing material 120 in which heating element 110 is embedded, and, usually, an outer sheath material 130 which may be needed to protect heating element 110 and encasing material 120. The shape of a conventional glow plug 100 is cylindrical, resembling a rod or a pencil. The nominal diameter of the tip 140, which glows, is in the range of from 5 mm to 15 mm and the entire length of the glow plug 100 is approximately 30 mm to 50 mm.

The prior art heating elements are either metallic or ceramic; the ceramic elements are constructed from composites of polycrystalline silicon nitrate, silicon carbide and molybdenum disilicide. The material into which the element is embedded is usually a ceramic material. The typical power rating of the glow plug is 100 watts and the glow plug temperature is typically 1200° C. with a response time (the time required to reach the high temperature from a cold start) that ranges from one second to ten seconds.

Micro-glow Plug Structure—FIGS. 2-3:

The micro-glow plug 200 according to the invention is preferably a single U-shaped structure, preferably made from a polymer-derived ceramic. In the most preferred embodiment, the ceramic is silicon carbon-nitride (SiCN), though other suitable ceramics may be used. Referring to FIG. 2, the U-shaped micro-glow plug 200 comprises a left arm 220 and a right arm 222 on either side of hot spot 230 at the tip of the U-shaped structure. At the base of left arm 220 and right arm 222 are left electrical contact pad 210 and right electrical contact pad 212.

Referring to FIG. 3, the thickness of the material can be varied anywhere from one hundredth of a millimeter (that is, a few tens of micrometers) up to one millimeter. The width of the arms can be varied anywhere from one millimeter to 50 microns. The region 230 of the hot spot is five to ten times thinner than the arms. In the preferred embodiment of FIG. 3, the width of arms 220 and 222 are preferably approximately 210 microns while the width of the hot spot 230 is preferably approximately 35 microns, or about six times thinner than left arm 220 and right arm 222. The width of left arm 220 and right arm 222 in comparison to the width of hot spot 230 allows current to flow through left arm 220 and right arm 222 to generate a high operating temperature at hot spot 230 while left arm 220 and right arm 222 remain relatively cool. The difference in temperature is due to a much higher current density at tip 230 as compared with the rest of the micro-glow plug 200 structure. The largest dimensions of the glow plug are: the length, i.e., the distance in the direction marked 1.1 mm of FIG. 3, which is in the vertical direction in the figure; and the overall width of the glow plug, i.e., the distance in the direction marked 1 mm in FIG. 3, which is in the horizontal direction in the figure. A feature of the invention is that the largest of these dimensions is generally 2 mm or less. Generally the tip width, that is the dimension labeled 35 microns in FIG. 3, is generally less than one-tenth of the dimension of the arms or less than 0.2 mm. As indicated in FIG. 3, in the preferred embodiment, the length is preferably about 1.1 mm and the overall width is about 1 mm, while the tip width is 35 microns. Since micro-glow plug 200 is a single U-shaped structure, the structure is produced from a single simple mold.

Ceramic Composition

The micro-glow plug is preferably made directly from polymer precursors. See, for example, B. Jaske, U. Klingebiel, R. Riedal, N. Doslik, and R. Gadow, “Cyclosilazanes and borazines: polymer precursors to silicon- and boron-containing ceramics”, Applied Organometallic Chemistry 14 (11), pp. 671-685, Nov. 2000, which is hereby incorporated by reference as though fully disclosed herein.

The polymer-derived ceramic for the present ultrahigh temperature micro-glow plug is made from three primary constituents: silicon, carbon and nitrogen. It is doped with boron to increase its electrical conductivity, which makes it more suitable for the micro-glow plug application. See, for example, P. A. Ramakrishnan, Y. T. Wang, D. Balzar, L. A. An, C. Haluschka, R. Riedel, and A. M. Hermann, “Silicoboron-carbonitride ceramics: A class of high-temperature, dopable electronic materials”, Applied Physics Letters 78 (20); pp. 3076-3078, May 14 2001, which is hereby incorporated by reference as though fully disclosed herein. The silicon carbon-nitride embodies mechanical and chemical properties that are needed to withstand thermal shock, oxidation and deformation at temperatures of up to 1500° C. See, for example, R. Raj, L. An, S. Shah, R. Riedel, C. Fasel and H. -J. Kleebe, “Oxidation Kinetics of an Amorphous Silicon Carbonitride Ceramic”. Journal of American Ceramic Society, Vol 84[8]; pp. 1803-10 (2001) and L. An, R. Riedel, C. Konetschny, H. -J. Kleebe, R. Raj, “Newtonian Viscosity of Amorphous Silicon Carbonitride at High Temperature”, J. Am. Ceram. Soc.81 (1998); pp. 1349-52, which are hereby incorporated by reference as though fully disclosed herein. The material is initially a transparent polymer liquid that can be easily shaped into micro-sized components using micro-casting or direct photolithographical patterning of the pre-ceramic.

After the liquid is formed in the mold, it is preferably dried, which can be by heating, exposure to radiation, exposure to vacuum, or any other conventional form of drying. Once solid polymer micro-components have been made, they are preferably crosslinked and pyrolyzed, preferably by heating, preferably in a nitrogen atmosphere. Thermal decomposition of the polymer transforms it into SiCN, which is a lustrous-black, amorphous bulk ceramic. By controlling the material processing steps, various properties such as electrical conductivity, oxidation and corrosion resistance, and thermal shock resistance are imparted to the material.

The composition of the ceramic material preferably comprises silicon, carbon and nitrogen described by the composition SiₓC_{y}N_{z}, where x, y and z fall into the following ranges:

x=1 to 4;

y=1.1 to 3.0; and

z=0 to 4.

In one embodiment, the composition is modified by the addition of an element such as boron, aluminum or phosphorous. The concentration of these elements is described relative to the concentration of silicon atoms. The atom concentration of any of these tertiary elements falls in a range of 0.0 to 2.0 for every silicon atom in the material. Addition of boron to the silicon carbon-nitride increases the electrical conductivity of the micro-glow plug.

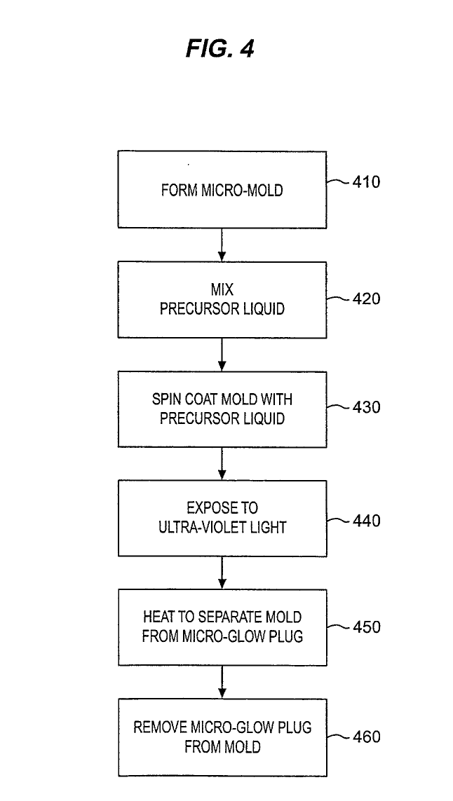

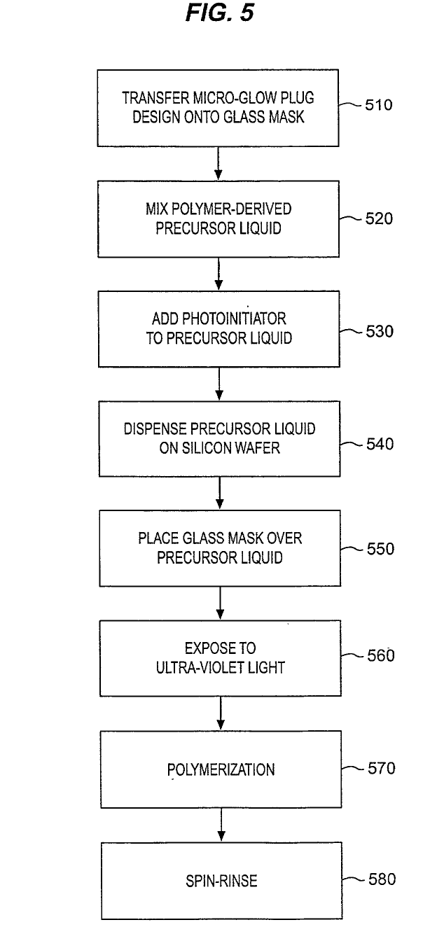

Molding the Ceramic Structure—FIGS. 4-5:

The overall fabrication process comprises forming solid polymer components from the liquid precursor, crosslinking and pyrolysis of the polymer components to convert the polymer into silicon carbon-nitride ceramic, annealing of the components to impart electrical conductivity, and packaging the micro-glow plugs.

Forming the solid polymer structure can be accomplished by two separate methods: microcasting or direct photolithographical patterning of the pre-ceramic. Referring to the flow diagram in FIG. 4, the microcasting process includes forming, or patterning, a micro-mold of the micro-glow plug structure in block 410 into photoresist on a substrate, preferably a silicon wafer, using photolithographical methods in a clean room. Preferably, coating the entire wafer with a thin layer of Teflon™, making the micro-glow plug easy to remove from the mold after the structure has been formed, completes the micro-mold. Preferably, prior to casting the precursor into the mold, in block 420 a photo-initiator is added to the liquid precursor to make it photosensitive. The precursor liquid is then cast into the molds in block 430 by a process commonly known as spin coating. Due to the Teflon™ layer on the wafer, the liquid accumulates only in the mold cavities and excess liquid is spun cleanly off the wafer. Other methods of deposition, such as misted deposition, may be used.

The precursor liquid is then solidified in block 440 to form a pre-ceramic solid material, preferably by exposing the wafer and the accumulated precursor liquid to ultra-violet light, after which the wafer is preferably placed in an oven for several minutes. The heat causes the SU8 layer to separate cleanly from the silicon wafer, leaving behind the solid polymer component that is easily removed from the Teflon™ coated silicon wafer, or mold. See, for example, L. A. Liew, W. G. Zhang, V. M. Bright, L. N. An, M. L. Dunn, and R. Raj, “Fabrication of SiCN ceramic MEMS using injectable polymer-precursor technique”. Sensors And Actuators A-Physical 89 (1-2); pp. 64-70, Mar. 20, 2001, which is hereby incorporated by reference as though fully disclosed herein.

An alternative method to obtaining the solid pre-ceramic structures is direct photolithographical patterning of the precursor liquid. Referring to the flow diagram in FIG. 5, the CAD designs of the micro-glow plug are transferred onto a glass mask in block 510, preferably using standard photolithographical procedures. The glass mask is then preferably coated with a layer of Teflon™ in the same manner as the silicon wafer mold previously discussed. The polymer-derived precursor is mixed in block 520 and a photoinitiator is preferably added to the precursor in block 530 to make it photosensitive.

The precursor liquid is then dispensed onto a silicon wafer in block 540, and in block 550 the glass mask is placed in contact with the liquid, being kept at a predetermined height by spacers of varying thickness. The spacer height thus determines the final micro-glow plug thickness. The precursor liquid is then exposed to ultra-violet light in block 560 so that the liquids are solidified corresponding to the openings in the glass mask. Following polymerization in block 570, the remaining liquid is removed from the wafer, preferably by spin-rinsing in block 580 with a solvent such as acetone or cyclohexane. The solid polymer preceramic components may then be removed from the silicon wafer by means of a razor blade with inert silicone oil as a lubricant.

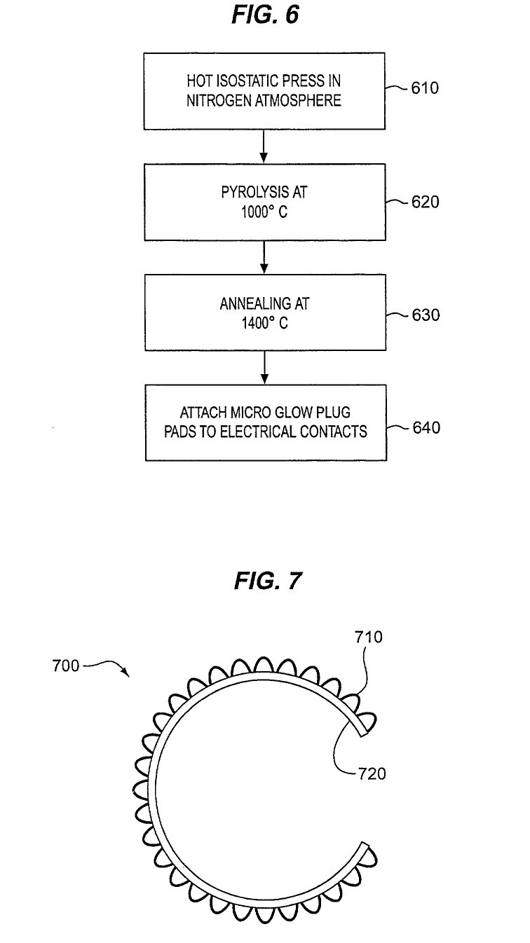

Treating the Micro-glow Plug—FIG. 6:

Referring to FIG. 6, once polymer micro-glow plug structures have been obtained using either of the above two forming methods, they are preferably treated, preferably by placing them in a hot isostatic press in a nitrogen atmosphere in block 610. The treating process is preferably by heating in a furnace, though it can be rapid thermal annealing (RTA), sometimes referred to as rapid thermal processing (RTP), or other conventional heating process. Preferably, the treating includes pyrolysis in block 620 and annealing in block 630; preferably, the pyrolyis is at a temperature within the range of from 900° C. to 1100° C., most preferably at 1000° C., and the annealing is at a temperature from 1300° C. to 1500° C., most preferably at 1400° C. During the treating, the polymer components are converted to electrically-conductive silicon carbon-nitride ceramic, undergoing about 30% linear shrinkage in the process. The resulting components exhibit room temperature DC resistively of less than 3 Ohm-cm.

In a preferred embodiment, the micro-glow plug is coated with an oxide coating to protect it from corrosion. The micro-glow plugs are then preferably attached to a suitable substrate in block 640 by means of conductive epoxy. The substrate may be patterned with electrical contacts onto which the micro-glow plug's bonding pads sit. Since only the tip of the micro-glow plug gets heated, the rest of the device, including the bonding pads, remains relatively cold, thus simplifying the packaging requirements.

The two ends, the bonding pads, of the U-shaped micro-glow plug are connected to electrical contacts. One bonding pad is connected to a positive electrical contact while the other is connected to a negative electrical contact. During operation, a voltage is applied to the positive and negative electrical contacts so that a current flows through one arm of the micro-glow plug, across the tip, to the other arm of the micro-glow plug. Referring to FIG. 2, the width of left arm 220 and right arm 222 in comparison to the width of hot spot 230 allows current to flow through left arm 220 and right arm 222 to generate an ultrahigh operating temperature at hot spot 230 while left arm 220 and right arm 222 remain relatively cool. The difference in temperature is due to the much higher current density at tip 230 as compared with the rest of the micro-glow plug 200 structure.

The operating characteristics of the micro-glow plug are such that the tip of the micro-glow plug reaches a glow temperature of up to 1500° C. and reaches the glow temperature in less than one second, typically one-half of a second or less from a cold start. The power required for the micro-glow plug to reach the glow temperature is decreased due to the micro size and requires less than one watt of power to reach and to maintain its highest operating temperature.

Decreasing the power required for the micro-glow plug to reach and maintain its operating temperature decreases the power required of the battery operating the vehicle in which the micro-glow plug is used.

Micro-glow Plug System—FIGS. 7-9:

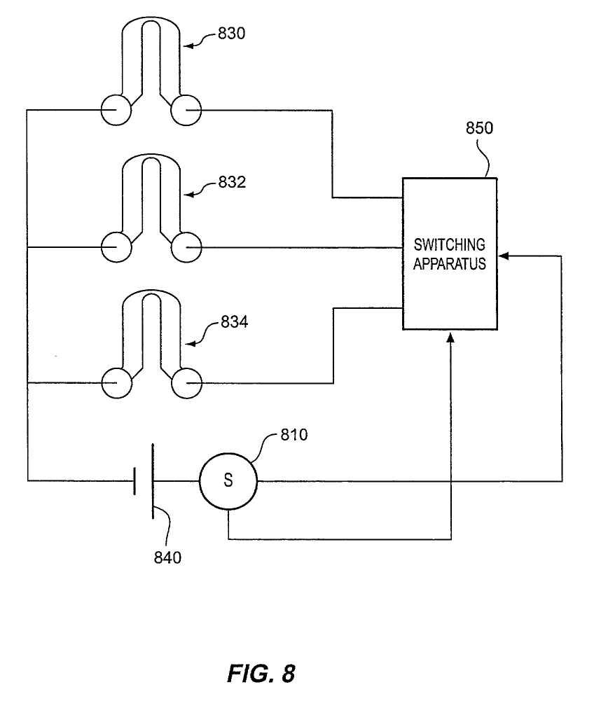

Referring to FIG. 7, in an embodiment of the present ultrahigh temperature micro-glow plug, a plurality of molded micro-glow plugs 710 are integrally connected to a non-conductive body 720 to form a micro-glow plug system 750 (MPS). Referring to the schematic diagram in FIG. 8, a current sensing device such as current meter 810 monitors the current drawn from battery 840 by the operational first micro-glow plug 830. When the current draw decreases to a predefined level, sensor 810 generates a signal indicating that first micro-glow plug 830 has failed and sends the signal to switching apparatus 850. Switching apparatus 850 receives the signal and switches the power supplied by battery 840 to the next successive micro-glow plug 832 or 834.

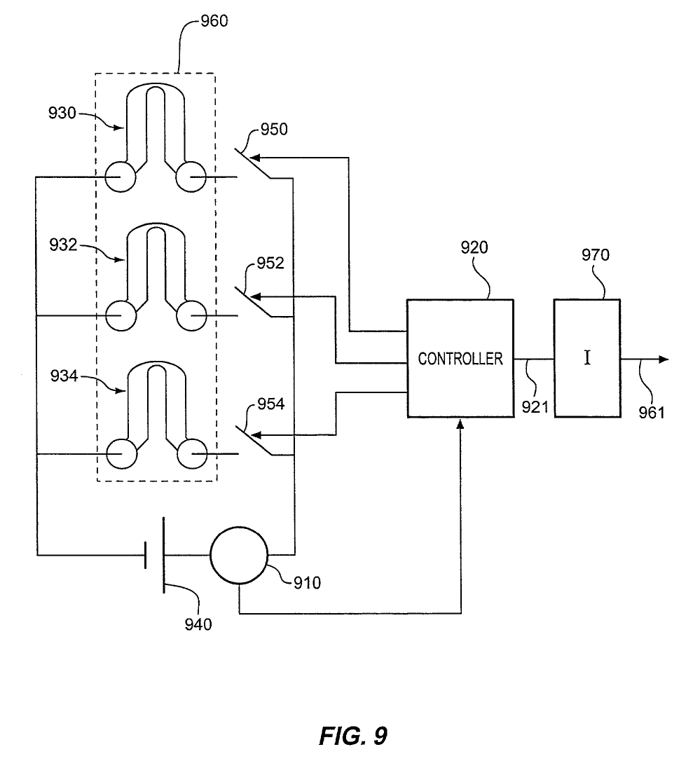

Referring to the schematic diagram in FIG. 9, MPS 900 includes a body 960 having a plurality of micro-glow plugs 930, 932, 934 attached to it. Preferably, the body 960 is cylindrical and ceramic, and the micro-glow plugs are an integral part of ceramic body 960. Each of micro-glow plugs 930, 932, and 934 is serially connected to switches 950, 952, and 954, respectively. The serial micro-glow plugs and corresponding switch are connected in parallel across a power source 940, a battery in this illustration. A current sensing device 910 is serially connected between the power source and the switches so that sensing device 910 can monitor the current drawn by the circuit and outputs a signal when the current falls below a predefined level as previously described.

Controller 920 controls the operation of switches 950, 952 and 954 and therefore the power supplied to micro-glow plugs 930, 932 and 934. When the MPS is initiated, controller 920 closes. One of the switches and the micro-glow plug corresponding to the closed switch is operational. When the current sensed by current sensing device 910 falls below a predetermined level, indicating the operational micro-glow plug has failed, a signal is sent from current sensing device 910 to controller 920. In response to the signal received from current sensing device 910, controller 920 opens that switch and closes a next switch.

Each time controller 920 switches, it passes a signal on line 921 to information circuit 970. Information circuit 970 in turn produces an electrical signal on line 961 providing information on the remaining expected life of said MPS. Preferably, information circuit 970 is a counter that is programmed with the total number of micro-glow plugs, counts the number of micro-glow plugs that have been used, and produces a signal representative of the number of glow plugs remaining.

Providing an apparatus having more than one micro-glow plug attached thereto increases the operational life of the apparatus without a corresponding increase in cost. Increasing the number of micro-glow plugs attached to the body can increase the total life of the micro-glow plug system. The design in this embodiment allows great flexibility in optimizing the performance and the cost of the micro-glow plug system.

While the present ultrahigh temperature micro-glow plug system is described and illustrated in FIGS. 8 and 9 with three micro-glow plugs, the system could be implemented with any number of micro-glow plugs. The schematic diagrams in FIGS. 8 and 9 are used to illustrate methods of implementing a system utilizing a plurality of micro-glow plugs and not as a limitation of the present ultrahigh temperature micro-glow plug system. Having disclosed the system as described, it will be obvious to those skilled in the art to implement the micro-glow plug system using a variety of configurations.

Micro-glow Plug Testing:

A temperature of 1300° C. to 1400° C. in the tip of the micro-glow plug was achieved with an electrical input of 12 volts and 50 milliamperes. The time taken to achieve the glow temperature was less than 10 milliseconds. Testing also concluded that the power required to reach the highest temperature of 1400° C. is approximately 0.6 watts.

As to alternative embodiments, those skilled in the art will appreciate that the present ultrahigh temperature micro-glow plug may be fabricated by alternative processes and may be utilized in other applications requiring a small-sized heating element that requires minimal power to reach a high temperature.

It is apparent that there has been described a micro-glow plug that fully satisfies the objects, aims, and advantages set forth above. While the micro-glow plug has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed is:

1. A method of fabricating a ceramic micro-glow plug, the method comprising:
providing a liquid precursor including chemical elements suitable for forming said ceramic;
forming a solid micro-glow plug utilizing said liquid precursor; and
treating said solid micro-glow plug to form an electrically conductive ceramic micro-glow plug.

2. The method of claim 1 wherein forming a solid micro-glow plug comprises:
forming a mold for the electrically conductive ceramic micro-glow plug,
applying said liquid precursor into the mold,
solidifying said liquid precursor in said mold, and
removing the micro-glow plug from said mold.

3. The method of claim 2 wherein said solidifying comprises exposing said molded precursor liquid to ultra-violet light.

4. The method of claim 2 wherein said solidifying comprises heating said precursor liquid.

5. The method of claim 2 wherein said forming a mold comprises forming said mold into a photoresist on a silicon wafer.

6. The method of claim 2 wherein said method further comprises coating said mold with a layer of Teflon™.

7. A method of claim 1 wherein said providing a precursor liquid includes adding a photo-initiator to make said precursor liquid photosensitive.

8. A method of claim 1 wherein said forming comprises spin-coating.

9. The method of claim 1 wherein said forming a solid micro-glow plug comprises a photolithographical patterning process.

10. The method of claim 9 wherein said photolithographical process comprises:
transferring a micro-glow plug design onto a glass mask;
coating said glass mask with a Teflon™ coating;
dispensing said liquid precursor on a substrate;
placing said glass mask in contact with said precursor on substrate spaced at a predetermined height wherein the predetermined height between the substrate and the glass mask determines the thickness of the solid micro-glow plug;
exposing the liquid precursor to ultra-violet light through said mask to solidify the liquid precursor according to the glass mask;
removing the remaining liquid precursor from the substrate; and
removing the solid micro-glow plug from the wafer.

11. The method of claim 1 wherein treating comprises pyrolysis of the solid micro-glow plug at a temperature of 900° C. to 1100° C.

12. The method of claim 11 wherein said pyrolysis comprises heating at a temperature of 1000° C.

13. The method of claim 1 wherein said treating comprises annealing the solid micro-glow plug at a temperature of 1300° C. to 1500° C.

14. The method of claim 13 wherein said annealing comprised heating at a temperature of 1400° C.

15. The method of claim 1 wherein said chemical elements include silicon, carbon and nitrogen, and said ceramic comprises a silicon carbon-nitride.

16. A micro-glow plug, comprising:
a ceramic heating element having a first arm having a first width, a second arm having a second width, and a tip having a third width that is less than said first and second widths, said first arm and second arm connected to said tip; and
a first connecting apparatus for electrically connecting a voltage source across the first arm and the second arm so that when current is applied to said connecting apparatus a current flows through the ceramic heating element wherein the current density at the tip is increased due to the decreased third width of the tip to generate a high operating temperature at the tip while the first arm and the second arm remain relatively cool.

17. The micro-glow plug of claim 16 wherein said first width and said second width are substantially equal.

18. The micro-glow plug of claim 16 wherein said ceramic heating element comprising a silicon, carbon, and nitrogen composition.

19. The micro-glow plug of claim 18 wherein the ceramic heating element of silicon, carbon, and nitrogen composition further comprises:
Siₓ wherein x ranges between 1.0 and 4.0;
C_{y} wherein y ranges between 1.1 and 3.0; and
N_{z}, wherein z ranges between 0.0 and 4.0.

20. The micro-glow plug of claim 18 wherein said ceramic heating element further comprises a metallic element.

21. The micro-glow plug of claim 19 wherein the atom concentration of said metallic element falls within a range of 0.0 to 2.0 for every silicon atom.

22. The micro-glow plug of claim 20 wherein said metallic element comprises boron.

23. The micro-glow plug of claim 20 wherein said metallic element comprises aluminum.

24. The micro-glow plug of claim 18, and further comprising phosphorous, wherein the atom concentration of the phosphorous falls within a range of 0.0 to 2.0 for every silicon atom.

25. The micro-glow plug of claim 16, further comprising an oxide coating to protect the ceramic heating element from corrosion.

26. The micro-glow plug of claim 16, further comprising:
a body having a first end and a second end;
two or more ceramic heating elements integrally connected to said first end of said body, said first arm of the two or more micro-glow plugs interconnected; and wherein:
said connecting apparatus comprises a switching voltage source and a switch apparatus for electrically connecting said switching voltage source across said interconnected first arm of the two or more ceramic heating elements and each second arm of said two or more ceramic heating elements so that a current flows through a first one of said two or more ceramic heating elements and said switching voltage source switches voltage to the next second arm of the next one of said two or more ceramic heating elements when said first one of said two or more ceramic heating elements fails.

27. The micro-glow plug of claim 26 wherein said body is cylindrical.

28. A micro-glow plug system comprising:
a body having two or more micro-glow plugs integrally connected to the body;
a switching apparatus for switching power between said two or more micro-glow plugs;
a sensor to monitor a current flow to said two or more micro-glow plugs wherein when said current flow falls below a predetermined level, said sensor sends a signal to said switching apparatus and said switching apparatus switches said power to a next one of said two or more micro-glow plugs.

29. The micro-glow plug system of claim 28, and further including a source of said power, and wherein said sensor is connected in serial between the switching apparatus and said power source.

30. The micro-glow plug system of claim 28 wherein said switching apparatus comprises a plurality of controlled switches each having a control terminal and a controller for switching said power to the control terminal of a corresponding one of said plurality of controlled switches.

31. A micro-glow plug made from a single ceramic material in which the largest dimension is 2 mm or less, and with a glow tip of a size 0.2 mm or less.

32. The micro-glow plug of claim 31 made of a material comprising silicon, carbon and nitrogen.

33. The micro-glow plug of claim 32 coated with an oxide coating to protect it from corrosion.

34. The micro-glow plug of claim 32 wherein said material is described by the composition SiₓC_{y}N_{z}, where x, y and z fall in the following ranges: x=1 to 4; y=1.1 to 3.0; and z=0 to 4.

35. The micro-glow plug of claim 34 wherein said material further comprises a metallic element.

36. The micro-glow plug of claim 35 wherein the atom concentration of said metallic element falls within a range of 0.0 to 2.0 for every silicon atom.

37. The micro-glow plug of claim 35 wherein said metallic element comprises boron.

38. The micro-glow plug of claim 35 wherein said metallic element comprises aluminum.

39. The micro-glow plug of claim 34, and further comprising phosphorous, wherein the atom concentration of the phosphorous falls within a range of 0.0 to 2.0 for every silicon atom.

40. The micro-glow plug of claim 31 coated with an oxide coating to protect it from corrosion.

41. The micro-glow plug of claim 31 wherein said glow tip reaches a temperature of from 1200° C. to 1600° C. for ignition.

42. The micro-glow plug of claim 31 wherein said glow tip is capable of reaching a temperature of 1500° C.

43. The micro-glow plug of claim 31 that uses 5.0 watts of power or less to reach and maintain its highest operating temperature.

44. The micro-glow plug of claim 31 that uses 1.0 watt of power or less to reach and maintain its highest operating temperature.

45. The micro-glow plug of claim 31 that reaches its glow temperature in one-half of a second or less from a cold start.

46. A micro-glow plug that reaches its glow temperature in one-half of a second or less from a cold start.

47. A micro-glow plug having a glow tip, a current carrying section for carrying current to said glow tip, a glow tip, and a plurality of contact pads for connecting to an electrical circuit, said glow tip having an electrical resistance of ten times or more as compared to said current carrying section.

48. A system of micro-glow plugs (MPS) comprising an array of micro-glow plugs connected on a single supporting device.

49. The system of claim 48 wherein the total number of micro-glow plugs in said MPS range from two to one thousand.

50. The system of claim 48, and further including an electrical circuit that switches the operation of said MPS from one of said micro-glows plug to the next until all of said micro-glow plugs in said MPS are exhausted.

51. The system of claim 48, and further including a circuit for producing an electrical signal providing information on the remaining expected life of said MPS.
